(19) United States
(12) Patent Application Publication
(10) Pub. No.: US 2007/0256632 A1
(43) Pub. Date: Nov. 8, 2007

(54) Systems and methods for clamping semiconductor wafers

(76) Inventor: Xuyen Pham, Fremont, CA (US)

Correspondence Address: Tue Nguyen, 496 Olive Ave., Fremont, CA, 94539, US

(21) Appl. No.: 11/408,663

(22) Filed: Apr. 21, 2006

(51) Int. Cl. B05C 11/02

(52) U.S. Cl. 118/52

(57) ABSTRACT

An apparatus for holding a rotatable wafer having a wafer side and a wafer edge includes one or more clamps proximally positioned around a wafer perimeter, each of said clamps including a clamp edge adapted to engage said wafer edge.

This invention relates to systems and methods for securing semiconductor wafers during spinning.

In semiconductor fabrication, various layers of insulating, conducting and semi-conducting materials are deposited to produce semiconductor devices that provide desired electrical functions in an integrated circuit (IC) device. FIG. 1 shows an exemplary of typical wafer processing apparatus. A wafer 10 is positioned above a wafer chuck 12, both of which are contained in a shroud 14. The chuck 12 is connected to one end of a spindle shaft 19, while the other end of the spindle shaft 19 is connected to a pulley 20. The shaft 19 is centered in a spindle housing 18 using a plurality of spindle bearings 16. The pulley 20 is driven by a belt 22, which in turn is connected to a motor pulley 24. The motor pulley 24 is connected to a motor 26 which, when activated, rotates the pulley 20 to rotate the shaft 19 and the chuck 12 to spin the wafer 10 resting above the chuck 12. The wafer is held in place by a wafer retaining device 50.

During fabrication, semiconductor processing apparatus treat wafer surfaces by furnishing required treating liquids and gases to a wafer surface while rotating the wafer at a high speed. Such spinning or rotating-type substrate processing requires an arrangement that minimizes slippage between a substrate and retaining members which hold the substrate while the substrate is spinning since slippage causes the substrate surface to be chipped and generated particles, and also causes dust to adhere to the substrate surface. This also causes the processing liquid to flow unevenly, which eventually deteriorates the quality of processing.

Generally, the wafer retaining mechanism is broadly classified into two types. One is a so called vacuum chuck type that conducts vacuum-suction to one side surface of the wafer, and the other is a type that holds the outer peripheral edge of the wafer by means of three or more chuck pieces. Since the treating can be applied to only one side surface of the wafer according to the former, the latter is chiefly employed when it is desired to treat both side surfaces simultaneously.

U.S. Pat. No. 4,788,994 discloses a wafer holding mechanism that horizontally holds, one at a time, wafers which are sequentially transported thereto. Wafers are treated with liquids such as an etching, rinsing liquid, and the like, at the same time that the wafer is rotated at a high speed. The mechanism includes a hollow rotary shaft having an upper end thrust into a housing, a rotary plate horizontally mounted on the upper end of the rotary shaft, chuck pieces provided on the rotary plate for holding an outer peripheral edge of the wafer, the chuck pieces being movable in the radial direction of the rotating plate between a holding position wherein the wafer is tightly held by the chuck pieces and a release position wherein the wafer is free to be removed from the chuck pieces.

U.S. Pat. No. 5,376,216 discloses a plurality of substrate holding members and a substrate pressing member being disposed on a rotation stage at a peripheral portion. The substrate pressing member includes a magnet and is pivotally supported by the rotation stage. A ring-shaped permanent magnet is located below the rotation stage and forms a ring around the rotation axis of the rotation stage. When a substrate mounted on the rotation stage is rotated and processed, the ring-shaped permanent magnet is positioned in the vicinity of the magnet of the substrate pressing member. This creates a magnetic force between the magnets, causing the substrate pressing member to pivot so that the substrate pressing member contacts the edge of the substrate with a predetermined amount of pressure.

U.S. Pat. No. 5,989,342 discloses a substrate holding apparatus that holds a rotating substrate without idly rotating the substrate and keeps the substrate in proper balance while the substrate is rotated. In a revolvable holding member, a column-shaped holding part is disposed on a top surface of a column-shaped supporting part, at an eccentric position with respect to a rotation axis of the supporting part. The revolvable holding member is supported by a rotation base for free rotation, and linked to a magnet holding part which incorporates a permanent magnet. On the other hand, a ring-shaped magnet which is disposed in a processing liquid collecting cup is freely driven by an air cylinder in a vertical direction. As the ring-shaped magnet is moved upward or downward and crosses a predetermined line as viewed in a positional relationship relative to the permanent magnet, which is at a height where the permanent magnet is disposed, the direction of a magnetic line of flux of the ring-shaped magnet is reversed. As a result, the direction of the revolving force which acts upon the permanent magnet is reversed, whereby the revolvable holding member holds or releases a substrate.

### SUMMARY

In a first aspect, an apparatus for holding a rotatable wafer having a wafer side and a wafer edge includes one or more clamps proximally positioned around a wafer perimeter, each of said clamps including a clamp edge adapted to engage said wafer edge.

In another aspect, an apparatus for holding a rotatable wafer having a wafer side and wafer edge clamp housing and a clamp rotatably positioned in said clamp housing, said clamp having a clamp edge adapted to engage said wafer edge.

Advantages of the system may include one or more of the following. The clamp provide for a substrate holding apparatus which, with a simple structure and securely holds and releases a substrate. The substrate can be rotated without causing idle rotation of the substrate, while keeping excellent balance.

These and other features, aspects and advantages of the present invention will become more apparent from the following detailed description of the present invention when taken in conjunction with the accompanying drawings.

### BRIEF DESCRIPTION OF THE DRAWINGS

The present invention will be readily understood by the following detailed description in conjunction with the accompanying drawings. To facilitate this description, like reference numerals designate like structural elements.

FIG. 1 shows an exemplary prior art of typical wafer processing apparatus.

FIG. 2 illustrates an exemplary first embodiment of a spin apparatus that can access both sides of a wafer.

FIGS. 3-4 show a perspective view and enlarged perspective view of the clamp of FIG. 2 securing a wafer with support pins.

FIG. 5 illustrates an exemplary wafer processing apparatus with a second embodiment of a wafer clamp in a clamped position.

FIG. 6 illustrates the second wafer clamp embodiment in an open position.

FIG. 7 shows top views of the wafer support stands and clamp of FIGS. 5-6 in a clamped position.

FIG. 8 illustrates the detail of wafer clamp in FIGS. 5-6.

FIG. 9 shows a perspective view of the wafer support stands and clamp shown in FIG. 5.

FIG. 10 shows a perspective view of a support clamp shown in FIG. 8.

FIG. 11 shows a perspective view of a support stand shown in FIG. 7

FIG. 12 shows a cross-sectional view of the wafer clamp in FIG. 10

FIG. 13 illustrates an exemplary wafer processing apparatus with a third embodiment of a wafer clamp.

FIG. 14 shows a perspective view of the clamps in FIG. 13 securing a wafer.

FIG. 15 shows a close-up view of the clamp of FIG. 14 securing a wafer.

FIG. 16 shows a cross-sectional view of the clamp in FIG. 15 securing a wafer.

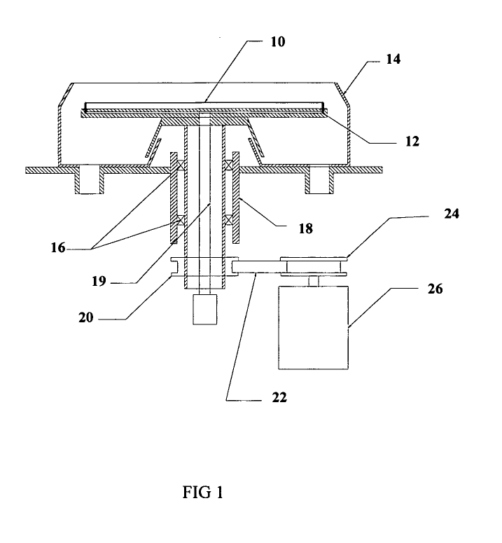

### DESCRIPTION

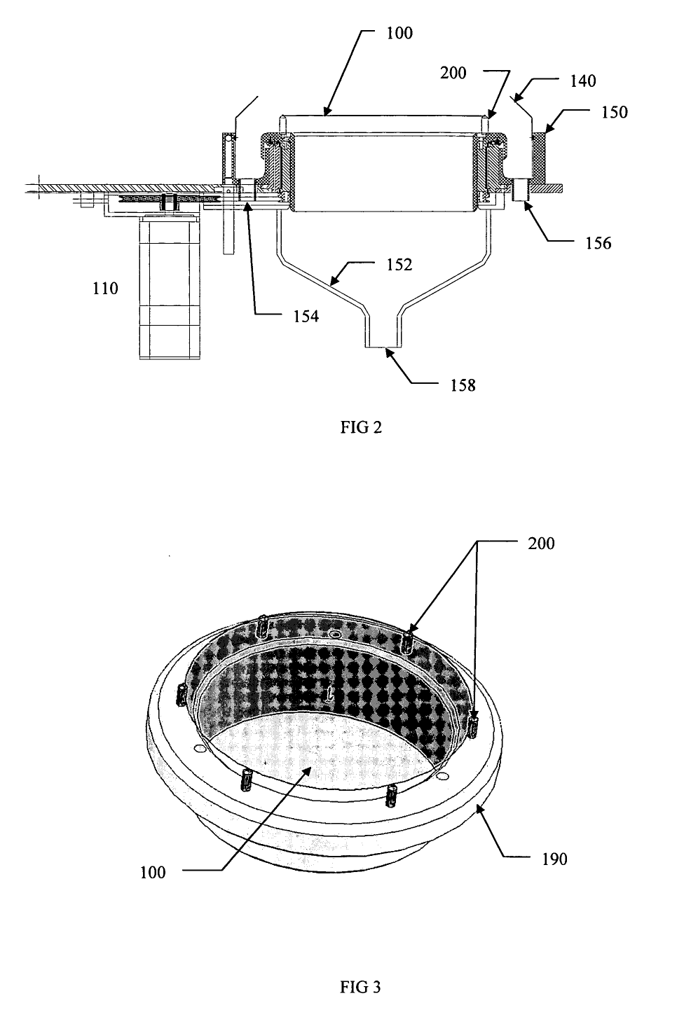

FIG. 2 shows an exemplary wafer processing apparatus with a first wafer clamp embodiment, in this case a clamp 200 with a pin to secure a wafer 100 at the wafer's edge. During operation, the wafer 100 is securely held in place by a wafer retaining device 200 and rotated by a drive assembly including a motor 110 mounted to the platform. The motor 110 rotates a pulley 114, which drives a belt to spin a spinning housing 190 which in turn spins the wafer 100. The assembly 200 includes an outer housing 132 to collect liquid and drain hole to vent air and liquid to a drainpipe.

A first tub or bowl 150 collects waste materials during the processing of the wafer 100, and a second tub or bowl 152 collects material generated during the processing of the bottom side of the wafer 100. Drains 154-156 are provided at the bottom of the first tub or bowl 150 to provide liquid and air exhaust for the first tub 150. Similarly, a drain 158 is provided at the bottom of the second tub 152 to remove materials from the second tub 152.

The bowl 150 has a shroud 140 to collect liquid and drain hole to vent air and liquid to a drainpipe. The shroud 140 can be moved up and down: the shroud 140 is in a lower position during wafer loading and un-loading, and is at an upper position during wafer rotation process sequences. The assembly moves the shroud 140 up and down using magnets located inside the outer housing 132. A labyrinth seal between inner and outer tub applied to prevent liquid getting into bearing. Additional protection, a felt ring seal is located between outer bearing drive housing to prevent moisture from getting into the bearing. From the outer bearing assembly, positive pressure airline supplies dry air to the bearing assembly. The foregoing protection prevents moisture from getting into the bearing assembly: there is no metallic material, hardware and mechanism that is exposed liquid. Hence, the arrangement advantageously prevents any corrosion and contamination to the substrate or wafer 100. Although a belt-drive system has been described, the drive system can also be a direct drive motor system.

The shroud 140 has a mesh that minimizes liquid from flashing back into the wafer during high speed spinning. The spacing between the shroud and mesh can be from 0.125″ to 1.0″, and preferably is 0.25″. The movement of the shroud is actuated by one or more actuators such as air cylinders. The moving end of the actuator is provided with a magnet that magnetically attaches to a corresponding magnet mounted on the shroud 140. The shroud 140 is at a first position (down position) during wafer loading or unloading and the shroud is at a second position (up position) during wafer rotation or processing.

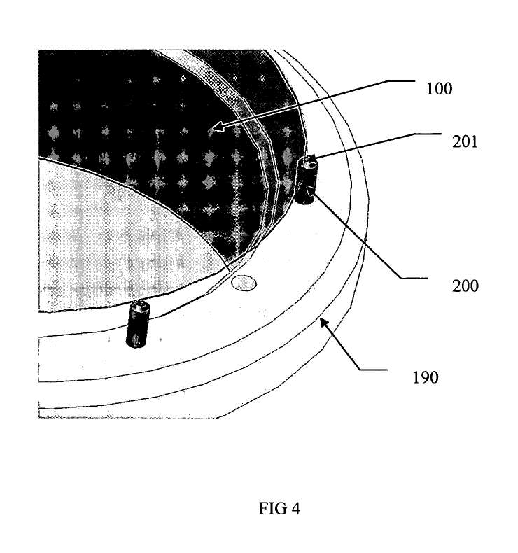

FIGS. 3-4 show a perspective view of the clamp of FIG. 2 securing a wafer. In the configuration shown in FIG. 3, six clamps 200 are positioned above the spinning housing 190 to support the wafer 100 during a spin wash cycle. In an alternate configuration, only three clamps 200 are needed to support and secure the wafer 100 at a low-speed such as during cleaning. FIG. 4 shows more detail a pin 201 extending from the clamp 200 to press against a wafer edge 101. A plurality of pins 201 extending from clamps 200 effectively constraints and secures the wafer 100 to the housing 190 at a relatively low spinning speed for washing purposes, for example.

FIG. 5 illustrates an exemplary wafer processing apparatus with a second embodiment of a wafer clamp in a clamped position. In the embodiment of FIG. 5, a clamp 300 supports and secures the wafer 100. The clamp 300 is magnetically activated by a cylinder 303 which moves a head 305 with a magnet mounted thereon. As shown in FIG. 5, when the shroud 140 is an up position, the cylinder 303 is at a rest position and exerts no influence on the clamp 300. In the absence of a contactless force from the head 305, the clamp 300 urges one or more contact points against a wafer edge to secure the wafer 100 to the wafer processing apparatus of FIG. 5. In an open position, the shroud 140 is in a down position which allows the cylinder 303 to move. When the head 305 approaches the clamp 300, the magnet on the head 305 repels a magnet mounted on the clamp 300, causing the clamp 300 to pivot to release the wafer 100.

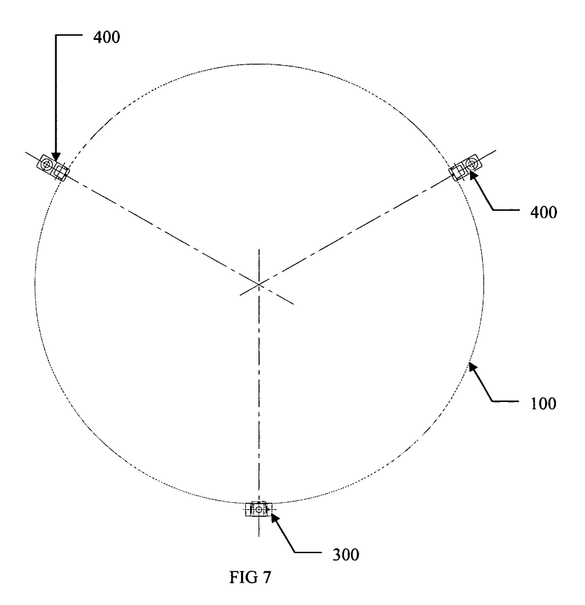

FIGS. 7-8 show a top view of the clamped wafer 100 and an enlarged top view of support clamps 300 when the wafer 100 is secured by the clamps 300. FIG. 7 shows that a clamp 300 engages the wafer 100 at the wafer edge. As shown therein, the clamp 300 and a plurality of wafer support stands 400 securely engage the wafer 100 during processing operation. FIG. 8 shows a top view of the clamp 300 in more detail as having clamp edges 351 and 352 that engage the edge of the wafer 100. Additionally, the wafer 100 rests above a wafer seat 353 provided on the clamp 300. In one embodiment, the distance between the clamp edges 351 and 352 is longer than the width of a wafer notch 340. With this configuration, only three clamps 300 are needed to securely hold the wafer 100.

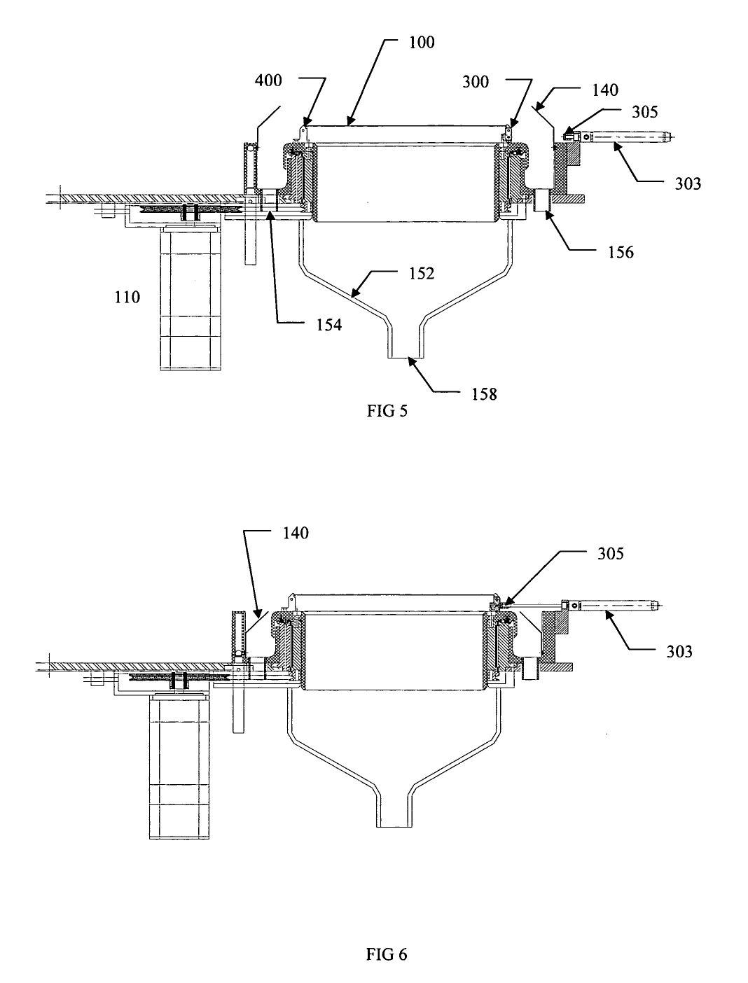

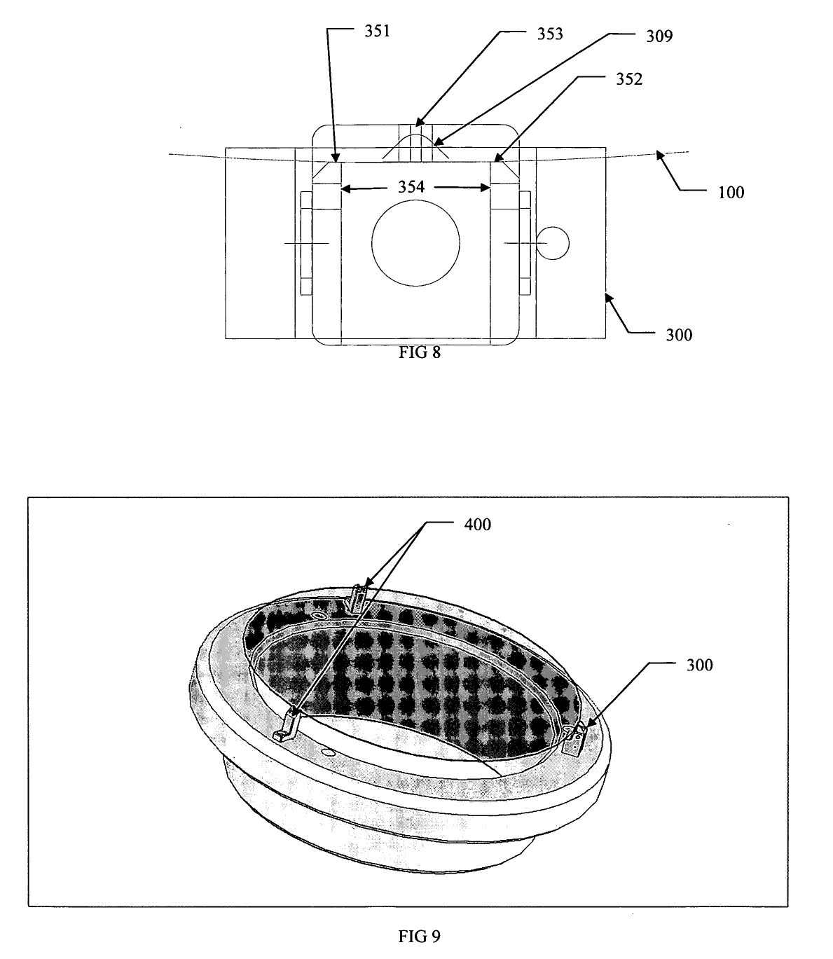

FIG. 9 illustrates an exemplary wafer processing apparatus with support clamps and the wafer clamp of FIGS. 5-6. As shown therein, the clamp 300 and a plurality of wafer support stands 400 securely engage the wafer 100 during processing operation.

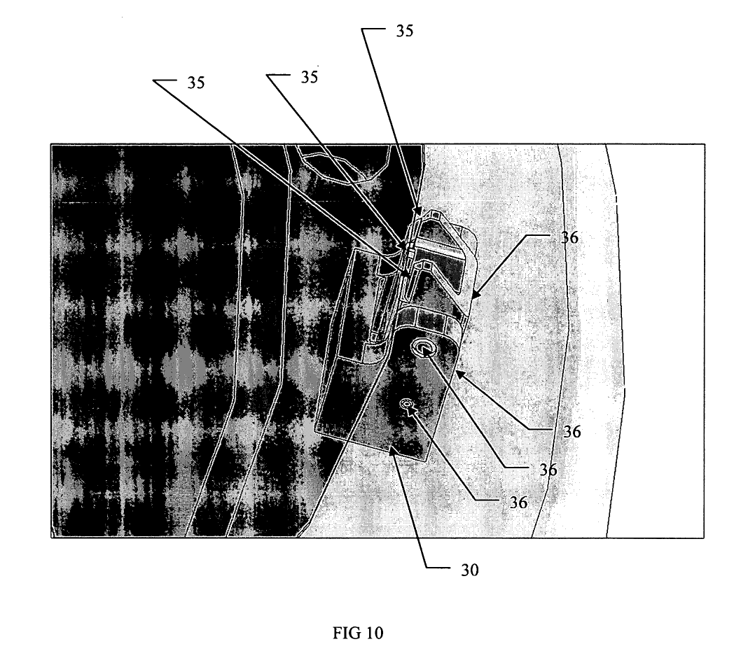

FIG. 10 shows a perspective view of the clamp shown in FIG. 9. As discussed above, the clamp 300 provides the seat 353 that allows the wafer 100 to be initially placed on the clamp 300. The clamp 300 also has two clamp edges 351 and 352 that engage the wafer 100 at the wafer edge 307. The clamp 300 is pivotally enclosed in a housing 360 and pivotally engages the wafer 100 through a pivot 362. A rotating limit pin 364 limits the rotation of the clamp 300 when actuated by the cylinder 303 with its magnetized head 305.

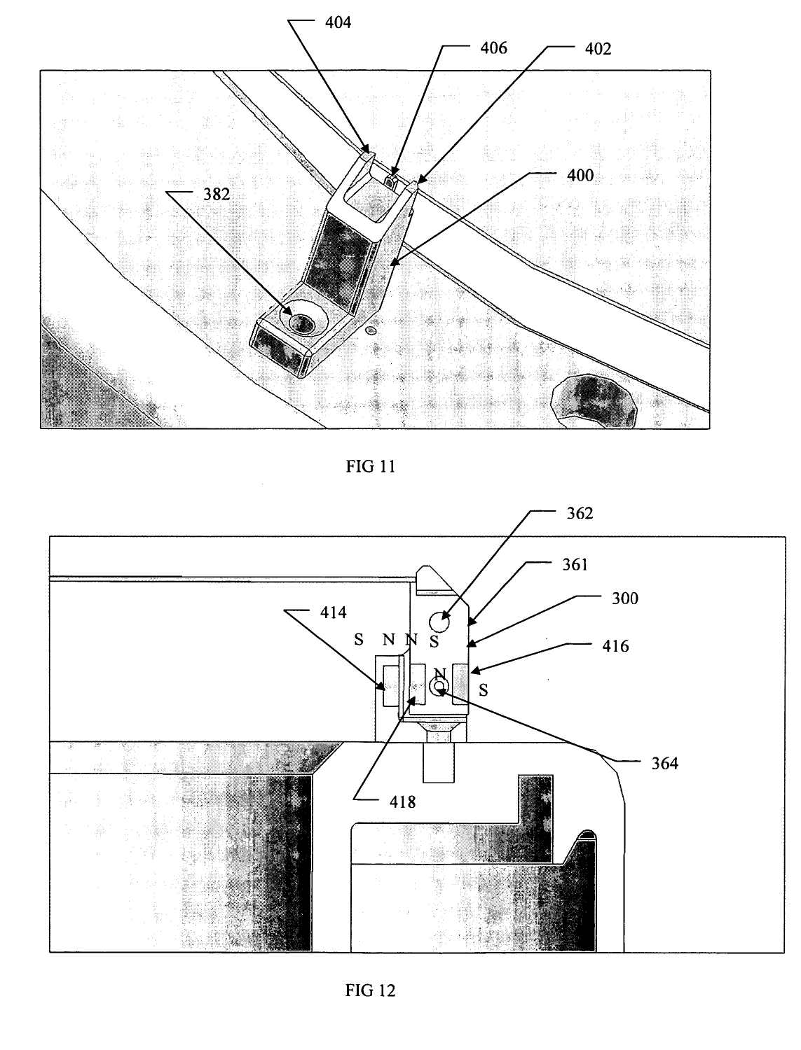

FIG. 11 shows a perspective view of a support stand 400 of FIG. 9. Similar to the clamp 300, the stand 400 provides stand edges 402 and 404 that engage the wafer edge. A stand seat 406 supports the wafer 100 at a rest position. The stand 400 has a body with an elevated portion. Further, an opening 382 is provided at the bottom of the stand 400 to secure the stand to the wafer processing apparatus. Together, stands 400 and the clamp 300 support the wafer 100 at rest and securely engages the wafer edge during operation.

FIG. 12 shows a cross-sectional view showing the support stand 400 and the wafer clamp 300. A top end of the clamp engages the wafer 100 at clamp contact 361, while a bottom end rests on a receptacle 363. A plurality of magnets 366-367 are positioned on the sides of the clamp 360. Correspondingly, an actuator (not shown) such as a cylinder moves an actuating magnet toward and away from the magnet 416 and causes the clamp to pivotally move about a pivot, subject to a limit pin 364 that prevents excessive pivoting. When the actuator moves toward the clamp, repulsive forces between magnets 416 and the actuator magnet (not shown) pivots the clamp into an open position so that the wafer 100 can be removed. When the actuator magnet is moved away from the clamp 360, an opposing magnet 414 repels the magnet 418 to cause the clamp to move back to a clamping position to securely hold the wafer 100.

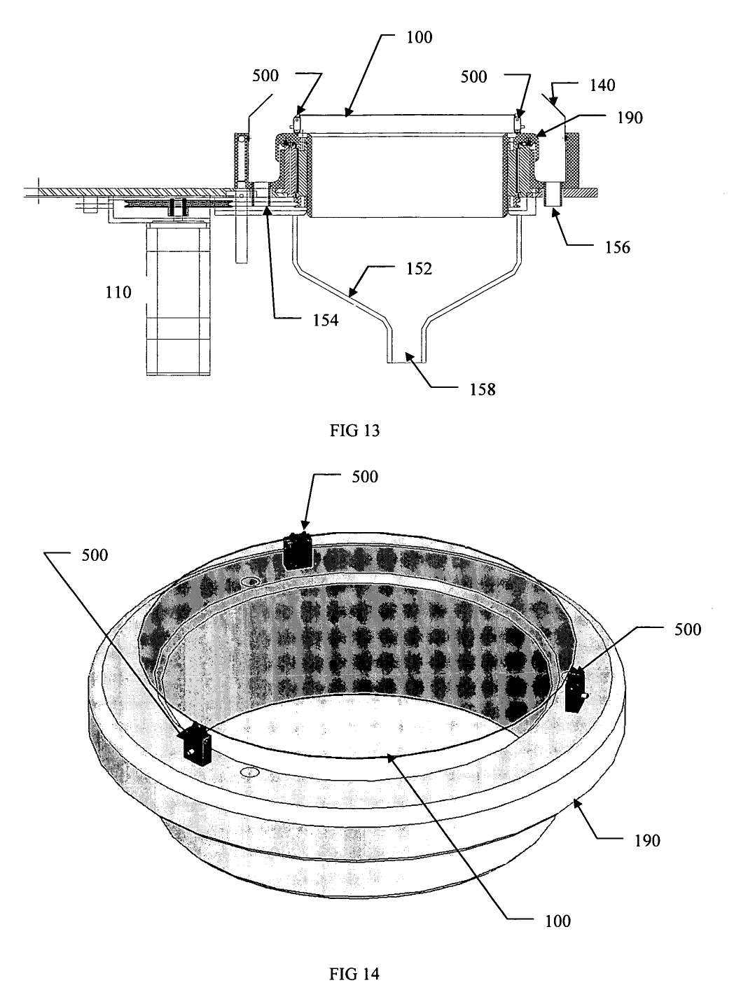

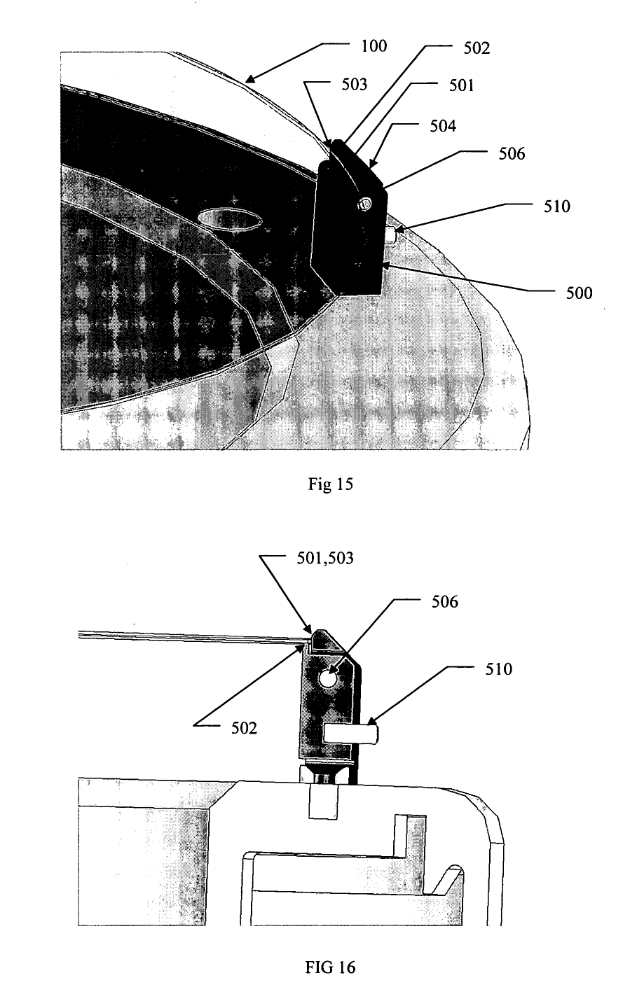

FIG. 13 illustrates an exemplary wafer processing apparatus with a fourth embodiment of a wafer clamp 500. The clamp 500 operates by centrifugal forces exerted on the clamp 500 during rotation of the wafer 100. FIGS. 14-15 show perspective view of the clamp 500 in securing a wafer, while FIG. 16 shows a cross-sectional view of the clamp 500 in securing the wafer 100. The clamp 500 is pivotally attached to a clamp housing 540 through a pivot 506 so that when the clamp 500 pivots toward the wafer 100, the clamp 500 secures the wafer 100 and vice versa, when the clamp 500 pivots away from the wafer 100, the wafer 100 can be removed.

Similar to the clamp 300, the clamp 500 provides a clamp edge 502 that engages the wafer edge 307. A seat 503 supports the wafer 100 at a rest position. The clamp 500 has a body with an elevated portion 504 that cooperates with the seat 503 in securing the wafer 100 at low speed. The clamp has a weight 510 mounted on one side. At high rotational speed, the weight 510 experiences a centrifugal force and moves away from the center of the wafer 100. As the weight 510 moves away from the wafer center, the edge 502 engages the wafer edge 307 to clamp the wafer 100 in place during rotation.

Although the invention has been described with reference to particular embodiments, the description is only an example of the inventor's application and should not be taken as limiting. Various adaptations and combinations of features of the embodiments disclosed are within the scope of the invention as defined by the following claims.

What is claimed is:

1. An apparatus for holding a rotatable wafer having a wafer side and a wafer edge, comprising:
one or more clamps proximally positioned around a wafer perimeter, each of said clamps including:
a clamp edge adapted to engage said wafer edge; and
a clamp seat adapted to support one side of said wafer.

2. The apparatus of claim 1, comprising a clamp housing adapted to rotatably receive one said clamps.

3. The apparatus of claim 1, comprising one or more clamp stands positioned proximally around the wafer perimeter with at one or more clamps.

4. The apparatus of claim 1, comprising a pivot coupled the clamp and the clamp housing.

5. The apparatus of claim 4, comprising a rotating limiter coupled to the clamp and clamp housing.

6. The apparatus of claim 1, wherein a magnetic force engages the clamp edge with the wafer edge.

7. The apparatus of claim 6, comprising a piston having a magnetic head to provide the magnetic force.

8. The apparatus of claim 1, wherein a centrifugal force engages the clamp edge with the wafer edge.

9. The apparatus of claim 1, comprising a moveable weight positioned on the clamp to provide a portion of the centrifugal force.

11. An apparatus for holding a rotatable wafer having a wafer side and a wafer edge, comprising:
a clamp housing; and
a clamp rotatably positioned in said clamp housing, said clamp having a clamp edge adapted to engage said wafer edge.

12. The apparatus of claim 1, comprising a pivot coupled the clamp and the clamp housing.

13. The apparatus of claim 4, comprising a rotating limiter coupled to the clamp and clamp housing.

14. The apparatus of claim 1, wherein a magnetic force engages the clamp edge with the wafer edge.

15. The apparatus of claim 14, comprising a piston having a magnetic head to provide the magnetic force.

16. The apparatus of claim 1, wherein a centrifugal force engages the clamp edge with the wafer edge.

17. The apparatus of claim 1, comprising a moveable weight positioned on the clamp to provide a portion of the centrifugal force.

18. The apparatus of claim 1, comprising a clamp seat adapted to support one side of said wafer.

19. An apparatus for holding a rotatable wafer having a wafer side and a wafer edge, comprising:
a clamp housing; and
a clamp rotatably positioned in said clamp housing, said clamp including:
a clamp edge adapted to engage said wafer edge; and
a clamp seat adapted to support one side of said wafer.
